(19) United States
(12) Patent Application Publication
(10) Pub. No.: US 2011/0230995 A1
(43) Pub. Date: Sep. 22, 2011

(54) A Method and System for Managing Compatibility of a Plurality of Devices within a Work Cell

(75) Inventors: Robert Frederick Irwin, Essex, VT (US); David Earle Morton, Neuhaeusgen (LU)

(73) Assignee: HUSKY INJECTION MOLDING SYSTEMS LTD., Bolton, ON (CA)

(21) Appl. No.: 13/129,595

(22) PCT Filed: Dec. 2, 2009
(86) PCT No.: PCT/US2009/066299

§ 371 Date: May 17, 2011

Related U.S. Application Data
(60) Provisional application No. 61/122,800, filed on Dec. 16, 2008.

(51) Int. Cl. G06F 19/00

(52) U.S. Cl. 700/99; 700/103

(57) ABSTRACT

According to embodiments of the present invention, there is provided a method and system for managing compatibility of a plurality of devices within a work cell. A method for managing a compatibility of a plurality of devices within a work cell in a molding site, the plurality of devices including a first device and a second device, is provided. The method comprises receiving an indication of a first unique parameter from the first device and a second unique parameter from the second device; based upon the first unique parameter and the second unique parameter, determining a compatibility indicator, which is indicative of compatibility between the first device and the second device; and responsive to the compatibility indicator being indicative of incompatibility between the first device and the second device, generating a conflict resolution parameter for rendering the first device and the second device compatible.

### FIELD OF THE INVENTION

The present invention generally relates to, but is not limited to, a molding system, and more specifically the present invention relates to, but is not limited to, a method and system for managing compatibility of a plurality of devices within a work cell.

### BACKGROUND OF THE INVENTION

Molding is a process by virtue of which a molded article can be formed from molding material by using a molding system. Various molded articles can be formed by using the molding process, such as an injection molding process. One example of the molded article that can be formed, for example, from polyethylene terephthalate (PET) material is a preform that is capable of being subsequently blow-molded into a beverage container, such as, a bottle and the like. Other examples of the molded articles include thin-wall containers (i.e. yogurt containers, cups, etc), medical appliances and the like.

As an illustration, injection molding of PET material involves heating the PET material (ex. PET pellets, PEN powder, PLA, etc.) to a homogeneous molten state and injecting, under pressure, the so-melted PET material is injected into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, etc.

It is not unusual for a converter (i.e. an entity who is using a molding machine to convert resin into molded articles) to change the molded articles produced, from time to time. For example, sometimes the type of the molded article is changed. In other cases, the design of the molded article is changed, as an example for preform molding, the neck finish may be changed, the length of the preform may be changed, etc. Within these situations, the converter may be required to change some portions of a work cell to accommodate the change. The work cell typically includes the injection molding machine, an associated mold and auxiliary equipment, such as pre-mold and/or post-mold treatment equipment). For example, the converter may have to change the mold and/or parts of the molding stack utilized within the mold and/or parts of the post-mold treatment devices.

U.S. patent application 2008/0098401 published to Weatherhead et al. on Apr. 24, 2008 discloses an arbitrating access to industrial resources as a function of controller identity. For example, a unique identifier can be associated with a control module that can distinguish the module from other components of a system. Upon receiving a request to control a resource, the identifier of the requesting module can be associated with that resource. In a case of multiple requests, an arbitrated ID can be chosen and added to an owner queue. The chosen ID is then published and, if the published identifier matches the module identifier, the module can assume control of the resource; if not, the module's request is placed into a request queue for further arbitration. The subject innovation provides for generally applicable arbitration that can reduce redundant code crafted for each module of a system, greatly reducing overhead costs associated with such redundancy.

U.S. patent application 2008/0097626 published on Apr. 24, 2008 to Reed et al. discloses an automation control system that can be efficiently developed and maintained as a hierarchical arrangement of configured components that pass process control parameters received from a control component and return reports back to the control component. In particular, control components compare a current configuration to a validated, saved configuration in order to report a configuration status as to whether a process can be conducted as validated. Yet, changes to the configuration of the automation control system that do not affect a validated portion do not preclude continued validated processing.

U.S. patent application 2008/0097642 published on Apr. 24, 2008 to Zwicker discloses a system and method that provides computer-assisted organization of workpieces to be processed in a production process, wherein the workpiece in question is subjected to at least one processing, preferably to a plurality of different processings. A workpiece position is assigned to each workpiece, and at least one, preferably several, workpiece positions are combined in a magazine. Each workpiece position includes a device for status determination of the respective workpiece position. A control unit is provided for controlling the individual workpiece positions, and a data-processing unit is provided, which communicates with the control unit and in which the information queried from the individual workpiece positions is processed and status data is generated.

U.S. patent application 2005/0143850 published on Jun. 30, 2005 to Pavlik et al. discloses a production machine that comprises a web server integrated control, said web server comprising software modules and at least one first software module comprising first means for realizing the control.

U.S. patent application 2007/0061033 published on Mar. 15, 2007 to Lucas et al. discloses a version control system helps to keep track of versions of process plant items that may represent, or be capable of representing, entities in a process plant. The process plant items may comprise, for example, module objects which may be capable of specifically representing process entities of the process plant. These module objects may be created from module class objects which may be capable of generically representing process entities of the process plant. Version data is stored and associated with a module object. The version data may comprise data indicative of a version of a module class object that was used to create the module object. The version data may also comprise data indicative of a version of the module object. Configuration systems, version control systems, viewing systems, debugging systems, run-time monitoring systems, asset management systems, etc., may examine or permit viewing of the version control data associated with an item.

U.S. Pat. No. 7,261,539 issued on Aug. 28, 2007 to Pitscheneder et al. discloses an injection molding machine with a mold that can be opened and closed, into the mold cavity of which a fluid molding compound, preferably plastic, can be injected, and with at least one reading device (12) for at least one transponder (13) arranged in the mold cavity (4).

U.S. Pat. No. 7,236,841 issued on Jun. 26, 2007 to Fischer et al. discloses a method and apparatus that includes a computer implemented injection molding configuring subsystem which enables a customer to interactively specify and design a system using a mix of parameters that the customer specifies and are manufacturing process determined. The configuring subsystem is connected to a computer network such as the Internet. The method and apparatus of the present invention further includes a computerized business and processing subsystem in communication with the configuring subsystem. The computerized business subsystem automatically provides a cost and schedule for a system configured by the configuring subsystem and additionally processes an order for the system. The processing subsystem automatically processes the customer's inputs and generates drawings for the configured system. Prior to receiving the customer's order, hot runner system components may be partially manufactured in a first phase and placed in inventory. The partially manufactured hot runner components may then be removed from inventory after receiving a customer's order, and further manufactured and assembled in accordance with the customer's parameters in a second phase.

U.S. Pat. No. 6,675,055 issued on Jun. 6, 2004 to Fischer discloses a method and apparatus that includes a computer implemented injection molding configuring subsystem which enables a customer to interactively specify and design a system using a mix of parameters that the customer specifies and are manufacturing process determined. The configuring subsystem is connected to a computer network such as the Internet. The method and apparatus of the present invention further includes a computerized business and processing subsystem in communication with the configuring subsystem. The computerized business subsystem automatically provides a cost and schedule for a system configured by the configuring subsystem and additionally processes an order for the system. The processing subsystem automatically processes the customer's inputs and generates drawings for the configured system.

### SUMMARY OF THE INVENTION

According to a first broad aspect of the present invention, there is provided a method for managing a compatibility of a plurality of devices within a work cell in a molding site, the plurality of devices including a first device and a second device. The method comprises receiving an indication of a first unique parameter from the first device and a second unique parameter from the second device; based upon the first unique parameter and the second unique parameter, determining a compatibility indicator, which is indicative of compatibility between the first device and the second device; and responsive to the compatibility indicator being indicative of incompatibility between the first device and the second device, generating a conflict resolution parameter for rendering the first device and the second device compatible.

According to a second broad aspect of the present invention, there is provided a supervisory computing apparatus associated with a work cell in a molding site, the work cell having a plurality of devices including a first device and a second device. The supervisory computing apparatus is configured to receive an indication of a first unique parameter from the first device and a second unique parameter from the second device; based upon the first unique parameter and the second unique parameter, determine a compatibility indicator, which is indicative of compatibility between the first device and the second device; and responsive to the compatibility indicator being indicative of incompatibility between the first device and the second device, generate a conflict resolution parameter for rendering the first device and the second device compatible.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a schematic representation of a molding site 100, which is configured to implement non-limiting embodiments of the present invention.

FIG. 2 depicts a compatibility database 202, implemented according to a non-limiting embodiment of the present invention.

FIG. 3 depicts a flow chart of a method 300, implemented according to a non-limiting embodiment of the present invention.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

Inventors have developed non-limiting embodiments of the present invention based at least partially on his appreciation of at least one problem that exists with prior art approaches to changing parts of the molding system. More specifically, inventors have appreciated that there currently exists no system that manages compatibility of devices within the molding system and/or within a work cell with other molding systems. Currently, converters rely on their expertise or vendor expertise to identify and resolve any conflict(s). This results in wasted time, inconsistent results and potential for missing conflicts, which may result in having to stop production to fix conflicts after-the-fact or damage to the devices within the molding system and/or inferior quality of the molded articles produced.

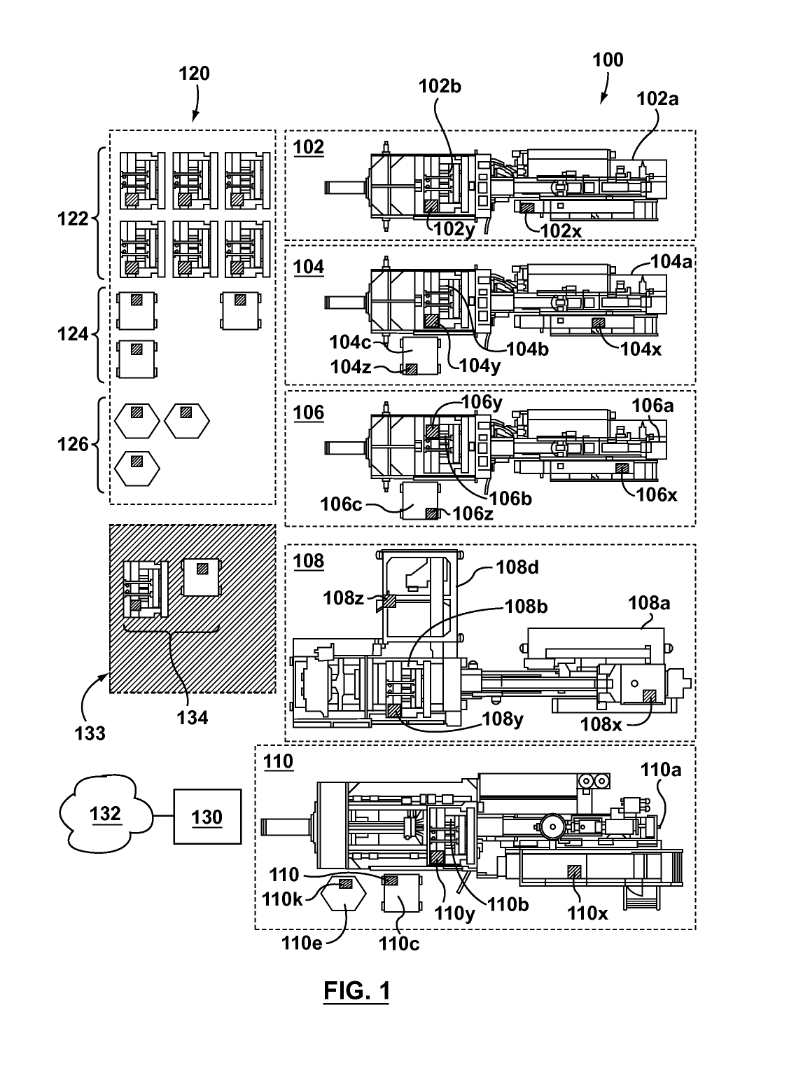

Reference will now be made to FIG. 1, which depicts a schematical layout of a molding site 100, which can be configured to implement embodiments of the present invention. The molding site 100 comprises a number of work cells, such as a first work cell 102, a second work cell 104, a third work cell 106, a fourth work cell 108 and a fifth work cell 110. Naturally, it is to be understood that the number of work cells is depicted as an example only. In alternative non-limiting embodiments of the present invention, the molding site 100 may have more or fewer of the work cells, as well as specific implementation of individual work cell may differ from that to be presented immediately below.

As an example of an illustration, the first work cell 102 includes a first injection molding machine 102a. The first injection molding machine 102a incorporates a number of known components, amongst which is a first mold 102b. Construction of the first injection molding machine 102a and its components is generally known in the art and, as such, will not be described here at any length. However, it is worthwhile noting that the first injection molding machine 102a is just one example of a device that can be potentially present within the first work cell 102. As such, teachings of the embodiments of the present invention should not be and are not intended to be limited to the injection molding art. Some alternative examples of the devices, to which embodiments of the present invention are applicable, include but are not limited to: extrusion molding equipment, stretch-blow molding equipment, compression molding equipment and other industrial equipment in general.

According to embodiments of the present invention, the first injection molding machine 102a is provided with a first machine identity entity 102x. The first machine identity entity 102x is configured to store an indication of a unique parameter associated with the first injection molding machine 102a. In some embodiments of the present invention, the first machine identity entity 102x is implemented as a Radio Frequency Identifier (RFID) tag. In some embodiments of the present invention, the RFID tag can be a passive RFID tag, in others it can be an active RFID tag. Within some of these embodiments of the present invention, the unique parameter can be a unique identifier. In other embodiments, the unique parameter can be compatibility indication (as will be discussed in greater detail herein below).

In alternative non-limiting embodiments of the present invention, the first machine identity entity 102x can be implemented as a bar code. Naturally, numerous alternative implementations are possible. The first mold 102b is provided with a first mold identity entity 102y, which is configured to store an indication of a unique identifier associated with the first mold 102b. The first mold identity entity 102y can be (but not necessarily is) implemented similarly to the first machine identity entity 102x.

The second work cell 104 includes a second injection molding machine 104a. The second injection molding machine 104a incorporates a number of known components, amongst which is a second mold 104b. Construction of the second injection molding machine 104a and its components is generally known in the art and, as such, will not be described here at any length. The second work cell 104 further includes a second controller 104c, which is configured to control one or more operations of the second injection molding machine 104a, as well as other devices potentially present within the second work cell 104.

According to embodiments of the present invention, the second injection molding machine 104a is provided with a second machine identity entity 104x. The second machine identity entity 104x is configured to store an indication of a unique parameter associated with the second injection molding machine 104a. In some embodiments of the present invention, the second machine identity entity 104x is implemented as a Radio Frequency Identifier (RFID) tag. In some embodiments of the present invention, the RFID tag can be a passive RFID tag, in others it can be an active RFID tag. Within some of these embodiments of the present invention, the unique parameter can be a unique identifier. In other embodiments, the unique parameter can be compatibility indication (as will be discussed in greater detail herein below).

In alternative non-limiting embodiments of the present invention, the second machine identity entity 104x can be implemented as a bar code. Naturally, numerous alternative implementations are possible. The second mold 104b is provided with a second mold identity entity 104y, which is configured to store an indication of a unique parameter associated with the second mold 104b. The second controller 104c is provided with a second controller identity entity 104z, which is configured to store a unique parameter associated with the second controller 104c. The second mold identity entity 104y and the second controller identity entity 104z can be (but not necessarily are) implemented similarly to the second machine identity entity 104x.

The third work cell 106 includes a third injection molding machine 106a. The third injection molding machine 106a incorporates a number of known components, amongst which is a third mold 106b. Construction of the third injection molding machine 106a and its components is generally known in the art and, as such, will not be described here at any length. The third work cell 106 further includes a third controller 106c, which is configured to control one or more operations of the third injection molding machine 106a, as well as other devices potentially present within the third work cell 106.

According to embodiments of the present invention, the third injection molding machine 106a is provided with a third machine identity entity 106x. The third machine identity entity 106x is configured to store an indication of a unique parameter associated with the third injection molding machine 106a. In some embodiments of the present invention, the third machine identity entity 106x is implemented as a Radio Frequency Identifier (RFID) tag. In some embodiments of the present invention, the RFID tag can be a passive RFID tag, in others it can be an active RFID tag. Within some of these embodiments of the present invention, the unique parameter can be a unique identifier. In other embodiments, the unique parameter can be compatibility indication (as will be discussed in greater detail herein below).

In alternative non-limiting embodiments of the present invention, the third machine identity entity 106x can be implemented as a bar code. Naturally, numerous alternative implementations are possible. The third mold 106b is provided with a third mold identity entity 106y, which is configured to store an indication of a unique parameter associated with the third mold 106b. The third controller 106c is provided with a third controller identity entity 106z, which is configured to store a unique parameter associated with the third controller 106c. The third mold identity entity 106y and the third controller identity entity 106z can be (but not necessarily are) implemented similarly to the third machine identity entity 106x.

The fourth work cell 108 includes a fourth injection molding machine 108a. The fourth injection molding machine 108a incorporates a number of known components, amongst which is a fourth mold 108b and a fourth post-mold treatment device 108d. Construction of the fourth injection molding machine 108a and its components is generally known in the art and, as such, will not be described here at any length.

According to embodiments of the present invention, the fourth injection molding machine 108a is provided with a fourth machine identity entity 108x. The fourth machine identity entity 108x is configured to store an indication of a unique parameter associated with the fourth injection molding machine 108a. In some embodiments of the present invention, the fourth machine identity entity 108x is implemented as a Radio Frequency Identifier (RFID) tag. In some embodiments of the present invention, the RFID tag can be a passive RFID tag, in others it can be an active RFID tag. Within some of these embodiments of the present invention, the unique parameter can be a unique identifier. In other embodiments, the unique parameter can be compatibility indication (as will be discussed in greater detail herein below).

In alternative non-limiting embodiments of the present invention, the fourth machine identity entity 108x can be implemented as a bar code. Naturally, numerous alternative implementations are possible. The fourth mold 108b is provided with a fourth mold identity entity 108y, which is configured to store an indication of a unique parameter associated with the fourth mold 108b. The fourth post-mold treatment device 108d is provided with a fourth treatment device identity entity 108z, which is configured to store a unique parameter associated with the fourth post-mold treatment device 108d. The fourth mold identity entity 108y and the fourth treatment device identity entity 108z can be (but not necessarily are) implemented similarly to the fourth machine identity entity 108x.

The fifth work cell 110 includes a fifth injection molding machine 110a. The fifth injection molding machine 110a incorporates a number of known components, amongst which is a fifth mold 110b. Construction of the fifth injection molding machine 110a and its components is generally known in the art and, as such, will not be described here at any length. The fifth work cell 110 further includes a fifth controller 110c, which is configured to control one or more operations of the fifth injection molding machine 110a, as well as other devices potentially present within the fifth work cell 110. The fifth work cell 110 further includes a fifth auxiliary device 110e, which can be implemented as a humidifier, a heater or any other downstream or upstream device, known to those of skill in the art.

According to embodiments of the present invention, the fifth injection molding machine 110a is provided with a fifth machine identity entity 110x. The fifth machine identity entity 110x is configured to store an indication of a unique parameter associated with the fifth injection molding machine 110a. In some embodiments of the present invention, the fifth machine identity entity 110x is implemented as a Radio Frequency Identifier (RFID) tag. In some embodiments of the present invention, the RFID tag can be a passive RFID tag, in others it can be an active RFID tag. Within some of these embodiments of the present invention, the unique parameter can be a unique identifier. In other embodiments, the unique parameter can be compatibility indication (as will be discussed in greater detail herein below).

In alternative non-limiting embodiments of the present invention, the fifth machine identity entity 110x can be implemented as a bar code. Naturally, numerous alternative implementations are possible. The fifth mold 110b is provided with a fifth mold identity entity 110y, which is configured to store an indication of a unique parameter associated with the fifth mold 110b. The fifth controller 110c is provided with a fifth controller identity entity 110z, which is configured to store a unique parameter associated with the fifth controller 110c. The fifth auxiliary device 110e is provided with a fifth auxiliary device identity entity 110k, which is configured to store an indication of a unique parameter associated with the fifth auxiliary device 110e. The fifth mold identity entity 110y, the fifth controller identity entity 110z and fifth auxiliary device identity entity 110k can be (but not necessarily are) implemented similarly to the fifth machine identity entity 110x.

It is noted that the number of identity entities provided within the molding site 100 is not particularly limited. For example, even though examples presented above contemplate that the injection molding machines provided within the molding site 100 are provided with a single instance of the identity entity, this needs not be so in every embodiment. For example, alternatively, specific components (platens, clamp, injection unit, etc.) of a given injection molding machine can be provided with individual identity entities. By the same token, even though the above description contemplates that a mold as a whole is provided with the identity entity, this needs not be so in every embodiment. For example, alternatively, each of the mold halves can be provided with a respective identity entity or even each stack component (or a portion thereof) can be provided with a dedicated respective identity entity.

The molding site 100 further includes an inventory area 120. The inventory area 120 includes devices that are available at or to the molding site 100, but which are currently not used in any given work cell. The inventory area 120 can be in a single physical location within the molding site 100 or it can be located in a distributed manner in several locations within the molding site 100 or, for that matter, at a location that is physically distinct from the molding site 100. The inventory area 120 is used to store a supply of spare parts, such as in this example, a supply of spare molds 122, a supply of spare controllers 124 and a supply of spare auxiliary devices 126.

According to embodiments of the present invention, each device stored within the inventory area 120 can be provided with a respective device identity entity (not separately numbered), which stores an indication of a respective unique parameter associated with the respective device stored within the inventory area 120. The respective device identity entity can be implemented similarly to those described herein above.

For the avoidance of doubt, it should be understood that in some embodiments of the present invention the “unique identifier” mentioned above can be any suitable combination of alpha-numerical symbols that can uniquely identify a given piece equipment. For example, each of the molds described above can be assigned a respective unique identifier. In alternative non-limiting embodiments of the present invention, a unique identifier can be assigned to a category of devices, such as a given category of auxiliary devices (such as chillers and the like), for uniquely identifying such the category of devices.

The molding site 100 further includes a supervisory computing apparatus 130, which can be implemented as a general-purpose computer or, alternatively, in a distributed manner between two or more computers, which can be desktops, workstations, laptops, Personal Digital Assistants and the like. The supervisory computing apparatus 130 can implement a number of routines, including methods implemented according to embodiments of the present invention, as will be described in greater detail herein below. It is worthwhile noting that the supervisory computing apparatus 130 can be, alternatively, located at a location that is distinct from the molding site 100. For example, the supervisory computing apparatus 130 can be located at a location associated with a vendor of one or more of the devices located within the molding site 100. Furthermore, the functionality of the supervisory computing apparatus 130 can be integrated into one of the controllers present within the molding site 100.

Irrespective of where the supervisory computing apparatus 130 is located, the supervisory computing apparatus 130 can be coupled to a communication network 132. The communication network 132 can be implemented as a wired communication network, a wireless communication network or the combination of the two. Additionally, the communication network 132 can be implemented as a Local Area Network, a Wide Area Network and the like. Furthermore, the communication network 132 can implement suitable secure communication protocols for encrypting data transmitted therethrough.

The communication network 132 is configured to communicatively connect the supervisory computing apparatus 130 to one or more devices located within the molding site 100, such as for example, a respective controller associated with the respective devices located within the molding site 100.

The supervisory computing apparatus 130 can maintain an ordered devices database 133. The ordered devices database 133 can maintain an indication of devices 134 (or each of a device 134) that have been ordered, but not yet delivered to the molding site 100.

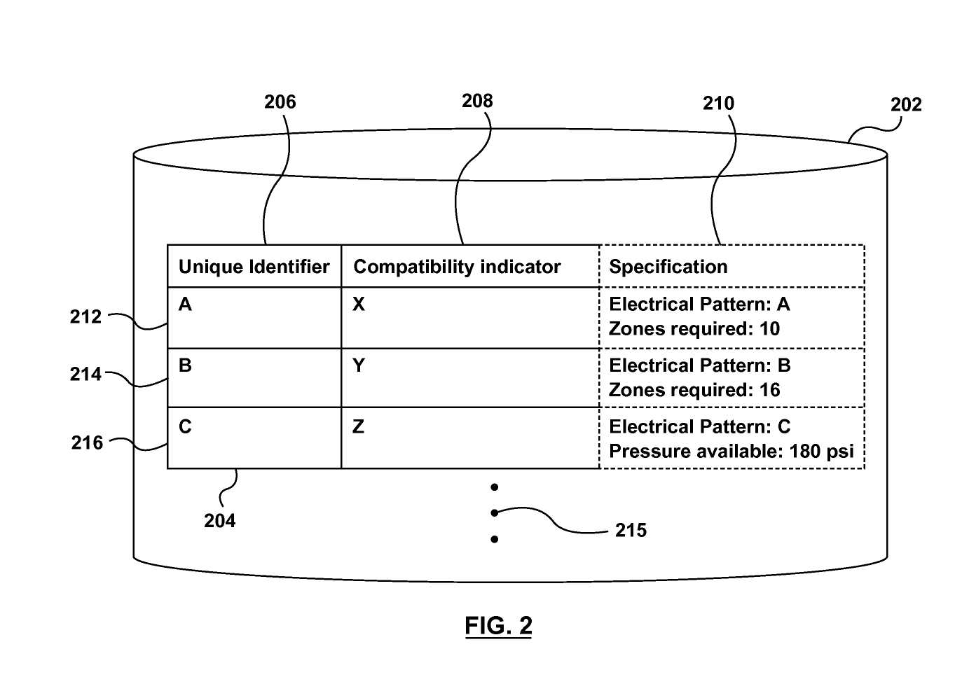

In those embodiments of the present invention where the unique parameter is a unique identifier, the supervisory computing apparatus 130 can further maintain a compatibility database 202, a non-limiting example of which is depicted in FIG. 2. The compatibility database 202 can maintain one or more tables, such as a compatibility table 204. The compatibility table correlates a unique identifier 206 to a compatibility indicator 208 and, optionally, to a specification 210

For example, a record 212 can be associated with the first mold 102b. The record 212 correlates the unique identifier 206 associated with the first mold 102b (which in this case is “A”) to the compatibility indicator 208 (which in this case is “X”). The compatibility indicator 208 is generally indicative of which other devices the first mold 102b is compatible with and/or which devices the first mold 102b is not compatible with. This indication can be expressed as specific unique identifier of the devices that the first mold 102b is compatible with, as specific unique identifier of the devices that the first mold 102b is not compatible with, as an indication of the general class of devices that the first mold 102b is compatible or incompatible with, a list of parameters associated with other devices that the first mold 102b is compatible or incompatible with and the like (or a combination of some or all of these indications).

Optionally, the record 212 also correlates the unique identifier 206 associated with the first mold 102b with a specification 210 associated with the first mold 102b, which in this example contains: “Electrical Pattern A; Zones required 10”, the specification 210 being indicative of the specific characteristics and/or requirements associated with the first mold 102b.

Similarly, a record 214 can be associated with a specific mold that has been ordered. Within this example, the record 214 correlates the unique identifier 206 associated with the specific mold that has been ordered (which in this case is “B”) to the compatibility indicator 208 (which in this case is “Y”). The compatibility indicator 208 is generally indicative of which other devices the specific mold that has been ordered is compatible with and/or which devices the specific mold that has been ordered is not compatible with. This indication can be expressed as specific unique identifier of the devices that the specific mold that has been ordered is compatible with, as specific unique identifier of the devices that the specific mold that has been ordered is not compatible with, as an indication of the general class of devices that the specific mold that has been ordered is compatible or incompatible with, a list of parameters associated with other devices that the specific mold that has been ordered is compatible or incompatible with and the like (or a combination of some or all of these indications).

Optionally, the record 212 also correlates the unique identifier 206 associated with the specific mold that has been ordered with a specification 210 associated with the specific mold that has been ordered, which in this example contains: “Electrical Pattern B; Zones required: 16”, the specification 210 being indicative of the specific characteristics and/or requirements associated with the specific mold that has been ordered.

By the same token, a record 216 can be associated with the fourth injection molding machine 108a. The record 216 correlates the unique identifier 206 associated with the fourth injection molding machine 108a (which in this case is “C”) to the compatibility indicator 208 (which in this case is “Z”). The compatibility indicator 208 is generally indicative of which other devices the fourth injection molding machine 108a is compatible with and/or which devices the fourth injection molding machine 108a is not compatible with. This indication can be expressed as specific unique identifier of the devices that the fourth injection molding machine 108a is compatible with, as specific unique identifier of the devices that the fourth injection molding machine 108a is not compatible with, as an indication of the general class of devices that the fourth injection molding machine 108a is compatible or incompatible with, a list of parameters associated with other devices that the fourth injection molding machine 108a is compatible or incompatible with and the like (or a combination of some or all of these indications).

Optionally, the record 216 also correlates the unique identifier 206 associated with the fourth injection molding machine 108a with a specification 210 associated with the fourth injection molding machine 108a, which in this example contains: “Electrical Pattern C; Pressure available: 180 psi”, the specification 210 being indicative of the specific characteristics and/or requirements associated with the fourth injection molding machine 108a.

Additionally, the compatibility table 204 can contain a number of additional records, jointly depicted at 215, representative of other devices within the molding site 100, such as one or more devices within the work cells, one or more devices within the inventory area 120, one or more devices on order (i.e. a new device) and other devices potentially present within the molding site 100.

How the compatibility table 204 is populated is not particularly limited. For example, compatibility table 204 can be populated based on information associated with devices within the molding site 100, based on vendor literature or other information provided from vendors (ex. manuals and other documents), other publicly available information (for example, from vendor web sites), empirical analysis of various devices and the like. Furthermore, the compatibility table 204 can be updated from time to time, for example, when new information about new or existing devices becomes available. The compatibility table 204 can be also updated when a device is ordered—for example, based on information stored within the ordered devices database 133.

In alternative embodiments of the present invention, compatibility indicator can be stored within the respective identity entity associated with a respective device.

Naturally, the compatibility indicator 208, as well as specification 210, whether stored within the compatibility database 202 or locally in the identity entity can be updated from time.

Additionally, even though above examples are presented as either local implementation (i.e. storing the compatibility parameter on the respective identity entity) or a centralized implementation (i.e. storing the compatibility parameter in a compatibility database 202), in alternative embodiments of the present invention some parts of a work cell can be implemented in a local fashion and others can be implemented in a centralized fashion.

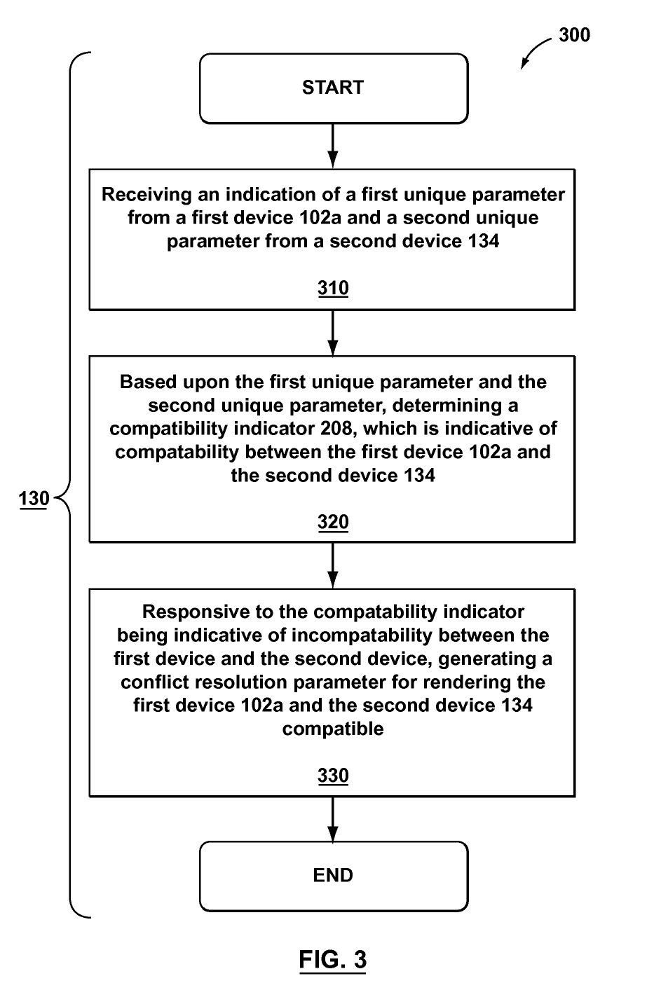

Given the architecture described herein above, it is possible to execute a method for managing compatibility of devices within the molding site 100. FIG. 3 illustrates a flow chart depicting a non-limiting example of a method 300. Method 300 can be conveniently executed by the supervisory computing apparatus 130 or another computing apparatus provided within the molding site 100 or within a different location.

Step 310—Receiving an Indication of a First Unique Parameter from a First Device and a Second Unique Parameter from a Second Device

The method 310 starts at step 310, where the supervisory computing apparatus 130 receives an indication of a first unique parameter from a first device and an indication of a second unique parameter from a second device.

In the example presented herein, it shall be assumed that step 310 is executed when it is desirable to convert the first injection molding machine 102a for a different production run and, more specifically, to change the first mold 102b for another mold configured to produce another type of a molded article, for example. Within this example, it is assumed that another mold is a new mold that has been ordered and an indication of which is stored in the ordered devices database 133 However, implementation of the method 300 and specifically an instance at which step 310 is implemented can vary. For example, step 310 can be executed when a new piece of equipment is detected in a given work cell (for example, by means of appreciating its RFID identifier) and the method is executed to determine compatibility of the new piece of equipment with other devices within the given work cell.

In some embodiments of the present invention, the unique parameter can be a unique identifier. Within the example being considered herein, as part of receiving the indication of the first unique identifier from the first device, the supervisory computing apparatus 130 receives an indication of a unique identifier associated with the first injection molding machine 102a. As part of receiving the indication of the second unique identifier from the second device, the supervisory computing apparatus 130 receives an indication of a unique identifier associated with a specific on-order mold destined to be installed within the molding machine 120a, for example, from the ordered devices database 133.

How the receiving of the indication of the first unique identifier and the second unique identifier is implemented is not particularly limited. As far as the indication of the second unique identifier associated with specific on-order mold is concerned, the supervisory computing apparatus 130 can receive such an indication from the ordered devices database 133 via the communication network 132, in response to a request transmitted to the ordered devices database 133. Alternatively, the indication of the second unique identifier can be manually entered into the supervisory computing apparatus 130.

As far as the indication of the first unique identifier is concerned, in those embodiments of the present invention where the first machine identity entity 102x is implemented as an RFID tag, appreciation of the indication of the first unique identifier can be done via an RFID reader, which can be built into a controller associated with the first injection molding machine 102a, or can be built into the supervisory computing apparatus 130 or can be a hand-held RFID reader. In those embodiments of the present invention, where the first machine identity entity 102x is implemented as a bar code, appreciation of the indication of the first unique identifier can be done via a bar code reader, either coupled (in a wired or a wireless manner) to the controller associated with the first injection molding machine 102a or a hand-held version thereof. Other implementations are, of course, possible. For example, it is contemplated that the first machine identity entity 102x can be implemented as a tag that is attached or engraved onto the first injection molding machine 102a bearing the indication of the unique identifier associated therewith. Within these embodiments, it is contemplated that the indication of the first unique identifier can be entered manually into the supervisory computing apparatus 130.

In alternative embodiments of the present invention, the unique parameter received as part of execution step 310 can be a compatibility parameter stored locally on the respective identity entity.

The supervisory computing apparatus 130 then proceeds to step 320.

### Step 320—Based Upon the First Unique Parameter and the Second Unique Parameter, Determining a Compatibility Indicator Which is Indicative of Compatibility Between the First Device and the Second Device

Then, at step 320, the supervisory computing apparatus 130, based upon the first unique parameter and the second unique parameter, determines a compatibility indicator which is indicative of compatibility between the first device and the second device.

Within those embodiments of the present invention where the unique parameter comprises a unique identifier, the supervisory computing apparatus 130 can access the compatibility database 202 and searches the compatibility table 204 based on the first unique identifier and the second unique identifier received as part of step 310.

The supervisory computing apparatus 130 then retrieves one of or both of the records associated with the first device and the second device. Within the specific example being considered herein, the supervisory computing apparatus 130 retrieves one or both of the record 212 associated with the first mold 102b and the record 214 associated with the specific mold that has been ordered.

Then, the supervisory computing apparatus 130 analyzes one or both of the respective compatibility indicators 208 in order to determine whether or not the specific mold that has been ordered is compatible with the first injection molding machine 102a. More specifically, the supervisory computing apparatus 130 analyzes one or both of the respective compatibility indicators “X” and “Y”.

In other embodiments of the present invention, the supervisory computing apparatus 130 can analyze (in addition to or instead of the compatibility indicators 208) data contained within the respective specification 210 in order to determine compatibility of the various devices. For example, where the specification 210 contains information about requirements of an electrical pattern, the supervisory computing apparatus 130 can determine whether respective specifications 210 vis-à-vis electrical patterns are compatible. Similarly, where specification 210 contains information about zones available and/or required, the supervisory computing apparatus 130 can determine whether the respective specifications 210 vis-à-vis zones available/required are compatible. Naturally, the actual logic used for this determination can be adapted to the specific needs of the molding site 100.

In a scenario, where supervisory computing apparatus 130 fails to locate a corresponding record within the compatibility database 202, an exception handling routine can be executed. Some examples of the exception handling routines include but are not limited to: providing a contact information for a vendor customer services representative, causing an electronic message to be sent a vendor for a resolution, attempting to update the information via the communication network 132, for example, from a vendor web site and the like.

In those embodiments of the present invention, where the unique parameter comprises a respective compatibility parameter, the supervisory computing apparatus 130 analyzes one or both of the so-received compatibility parameters to determine whether the specific mold that has been ordered is not compatible with the first injection molding machine 102a.

If the supervisory computing apparatus 130 determines that the specific mold that has been ordered is compatible with the first injection molding machine 102a, the supervisory computing apparatus 130 returns to execution of step 310, where it awaits receipt of an indication of another first unique identifier and an indication of another second unique identifier. Additionally, the supervisory computing apparatus 130 can present a user (not depicted) an indication of the compatibility of the specific mold that has been ordered and the first injection molding machine 102a. This can be done by means of a message on a human-machine interface or other suitable means (visual, audible or the like). On the other hand, if the supervisory computing apparatus 130 determines that the specific mold that has been ordered is not compatible with the first injection molding machine 102a (i.e. when the compatibility indicator is indicative of incompatibility between the first device and the second device), the supervisory computing apparatus 130 proceeds to execution of step 330.

Step 330—Responsive to the Compatibility Indicator being Indicative of Incompatibility Between the First Device and the Second Device, Generating a Conflict Resolution Parameter for Rendering the First Device and the Second Device Compatible

Next, as part of executing step 330, the supervisory computing apparatus 130 generates a conflict resolution parameter, the conflict resolution parameter for rendering the first device and the second device compatible.

According to embodiments of the present invention, several types of the conflict resolution parameters are contemplated. Examples of such conflict resolution parameters include, but are not limited to:
Reconfiguration of one or both of the first device and the second device;
Upgrading a software associated with the first device and/or the second device and/or a controller that controls the first device and/or the second device;
Providing a third device that may render the first device and the second device compatible, for example, providing the third device from the inventory area 120 or ordering the third device from a vendor;
Providing a third device that is currently employed in a different work cell within the molding site 100;
Providing equipment options that can be activated or obtained for the first device and/or the second device to render them compatible;
Providing an indication of a third device that should be installed instead of the first device and/or the second device in order to make the overall arrangement within the work cell compatible.

As part of the step 330, the supervisory computing apparatus 130 can further release the conflict resolution parameter to trigger execution of an action that would render the first device and the second device compatible.

For example, in those embodiments of the present invention, where the conflict resolution parameter is indicative of a requirement to obtain the third device to render the first device and the second device compatible, the supervisory computing apparatus 130 can release the conflict resolution parameter in order to determine whether the third device is already present within the first work cell 102. Within these embodiments, the method 300 can loop back to step 310, where it would receive additionally an indication of a third unique parameter associated with the first device (if it is present within the first work cell 102) and the determination would be repeated with the three devices, as substantially discussed above.

Additionally or alternatively, the supervisory computing apparatus 130 can release the conflict resolution parameter in order to determine whether the third device is available within the inventory area 120. Additionally, installation of such the third device into the first work cell 102. Alternatively, the supervisory computing apparatus 130 can release the conflict resolution parameter in order to cause an order to be transmitted to a vendor of the third device to order such the third device.

The conflict resolution parameter can be indicative of more than one of possible avenues (i.e. actions) to render the first device and the second device compatible. For example, the supervisory computing apparatus 130 may have determined that the electrical pattern associated with the first device is not compatible with the electrical pattern associated with the second device. Within these embodiments, the conflict resolution parameter may include the following conflict resolution options:
Reconfigure (i.e. rewire) the first device and/or the second device;
Replace one of the first device and the second device with a third device which is compatible with the other one of the first device and/or the second device, respectively;
Obtain a new third device that is compatible with the other one of the first device and/or the second device, respectively.

Even though embodiments of the present invention described above have been described in respect to a first device and a second device, method 300 can be executed with a third device and a number of additional devices. For example, when the first device, the second device and the third device are present as part of executing method 300, as part of executing step 310, the supervisory computing apparatus 130 receives:
An indication of a first unique identifier associated with a first device;
An indication of a second unique identifier associated with a second device; and
An indication of a third unique identifier associated with a third device.

Naturally, a respective unique identifier associated with respective additional devices can be received. Remainder of the steps of method 300 is augmented accordingly.

In the general sense of description, the various devices within the work cells described above (such as, the first injection molding machine 102a, the first mold 102b, a device within the supply of spare molds 122, a device within the supply of spare controllers 124 and a device within the supply of spare auxiliary devices 126 and so on) can be thought of as a first device, a second device, a third device, a fourth device and a fifth device (and so on).

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described.

Therefore, what is to be protected by way of Letters Patent are limited only by the scope of the following claims:

1. A method for managing a compatibility of a plurality of devices within a work cell in a molding site, the plurality of devices including a first device and a second device, the method comprising:
receiving an indication of a first unique parameter from the first device and a second unique parameter from the second device;
based upon the first unique parameter and the second unique parameter, determining a compatibility indicator, which is indicative of compatibility between the first device and the second device; and
responsive to the compatibility indicator being indicative of incompatibility between the first device and the second device, generating a conflict resolution parameter for rendering the first device and the second device compatible.

2. The method of claim 1, wherein one of said first device and said second device is a device existing within the work cell.

3. The method of claim 1, wherein one of said first device and said second device is a new device that is destined for the work cell.

4. The method of claim 1, wherein one of said first device and said second device is a device (122, 124, 126) stored within an inventory area.

5. The method of claim 1, wherein one of said first device and said second device is a device that has been ordered.

6. The method of claim 1, wherein said receiving is executed in response to detecting one of the first device and the second device within the work cell, the one of the first device and the second device being a new device for the work cell.

7. The method of claim 1, wherein said first unique parameter comprises one of a unique identifier and the compatibility indicator.

8. The method of claim 1, wherein said second unique parameter comprises one of a unique identifier and the compatibility indicator.

9. The method of claim 1, wherein at least one of said first unique parameter and said second unique parameter comprises a respective unique identifier.

10. The method of claim 9, wherein said determining comprises accessing a compatibility database that stores an indication of a given compatibility indicator correlated to said respective unique identifier.

11. The method of claim 1, wherein said conflict resolution parameter is indicative of an action selected from one or more of:
reconfiguring one or both of the first device and the second device;
upgrading a software associated with at least one of the first device, the second device and a controller that controls one or both of the first device or the second device;
providing a third device that may render the first device and the second device compatible;
providing a fourth device that is currently employed in a different work cell within the molding site;
providing equipment options that can be one of activated or obtained for the first device or the second device to render them compatible;
providing an indication of a fifth device that should be installed instead of the first device or the second device in order to make an overall arrangement within the work cell as compatible.

12. The method of claim 1, wherein said receiving comprises receiving a respective indication from a respective RFID tag associated with the first device and the second device.

13. The method of claim 1, wherein said receiving comprises receiving a respective indication from a respective bar code tag associated with the first device and the second device.

14. The method of claim 1, wherein said indication of said first unique parameter is received from a first identity entity associated with the first device.

15. The method of claim 1, wherein said indication of said second unique parameter is received from an identity entity associated with the second device.

16. The method of claim 1, wherein said conflict resolution parameter comprises an indication of a requirement to provide a third device that may render the first device and the second device compatible; and wherein the method further comprises:
determining if the third device is currently present within the work cell.

17. The method of claim 16, further comprising receiving an indication of a third unique parameter associated with the third device and repeating said determining and said generating based on said first unique parameter, said second unique parameter and said third unique parameter.

18. The method of claim 1, further comprising releasing the conflict resolution parameter to trigger execution of an action to render the first device and the second device as compatible.

19. A supervisory computing apparatus associated with a work cell in a molding site, the work cell having a plurality of devices including a first device and a second device, the supervisory computing apparatus configured to:
receive an indication of a first unique parameter from the first device and a second unique parameter from the second device;
based upon the first unique parameter and the second unique parameter, determine a compatibility indicator, which is indicative of compatibility between the first device and the second device; and
responsive to the compatibility indicator being indicative of incompatibility between the first device and the second device, generate a conflict resolution parameter for rendering the first device and the second device compatible.
